(19) United States
(12) Patent Application Publication
(10) Pub. No.: US 2009/0225235 A1
(43) Pub. Date: Sep. 10, 2009

(54) PROJECTION-TYPE PICTURE DISPLAY DEVICE

(75) Inventors: Takeshi Fujisaki, Amagasaki-shi (JP); Kenji Ofune, Higashi Osaka-shi (JP)

Correspondence Address: OCCHIUTI ROHLICEK & TSAO, LLP, 10 FAWCETT STREET, CAMBRIDGE, MA, 02138, US

(73) Assignee: Sanyo Electric Co., Ltd., Moriguchi-shi (JP)

(21) Appl. No.: 12/397,539

(22) Filed: Mar. 4, 2009

(30) Foreign Application Priority Data
Mar. 7, 2008 (JP) 2008-058231

(51) Int. Cl. H04N 3/26

(52) U.S. Cl. 348/745; 348/E03.048

(57) ABSTRACT

A projection-type picture display device for displaying an entire OSD image in a state superimposed on a picture without any part of the OSD image overhanging from the picture. An aspect ratio changing unit adjusts the size of the picture by changing an aspect ratio of the picture. An image generation unit generates the OSD image including characters superimposed on the picture. An image synthesizing unit synthesizes the OSD image with the picture of which the aspect ratio has been changed to superimpose the OSD image on the picture. A trapezoidal distortion correction unit performs trapezoidal distortion correction on the picture that has been synthesized with the OSD image in the image synthesizing unit. The image generation unit adjusts the size of the characters in the OSD image in accordance with the size of the picture of which the aspect ratio has been changed.

### CROSS-REFERENCE TO RELATED APPLICATIONS

This application is based upon and claims the benefit of priority from the prior Japanese Patent Application No. 2008-058231, filed on Mar. 7, 2008, the entire contents of which are incorporated herein by reference.

### BACKGROUND OF THE INVENTION

The present invention relates to a projection-type picture display device for projecting and displaying pictures.

Projection-type picture display devices such as liquid crystal display projectors have become popular. A projection-type video display projects and displays pictures on a screen. A typical liquid crystal display projector processes a picture signal input from an external device in a predetermined manner and provides the processed picture signal to a liquid crystal driver. Based on the picture signal, the liquid crystal driver applies a drive voltage to each display element in the liquid crystal panel to drive the liquid crystal panel and form a picture on a liquid crystal panel. In the liquid crystal display projector, light emitted from a light source is transmitted through the liquid crystal panel to generate picture light, which is projected from a projection lens and onto a screen. In this manner, the liquid crystal projects pictures.

The projection-type picture display device for projecting and displaying pictures may not correctly display a picture depending on how the display device is set up. Referring to FIG. 1A, for example, when a liquid crystal display projector 101, which is a projection-type picture display device, when picture light L projected from a projection lens 108 has an optical axis A, which orthogonally intersects a screen S, a rectangular picture is correctly displayed on the screen S. However, if the optical axis A of the picture light L, which is projected from the projection lens 108 of the liquid crystal display projector 101, does not orthogonally intersect the screen S, a rectangular picture is not displayed on the screen S.

Referring to FIG. 2A, when the liquid crystal display projector 101 is set up at a position located diagonally downward from the screen S and the picture light L is projected diagonally from the lower side of the screen S, the optical axis A of the picture light L projected from the projection lens 108 of the liquid crystal display projector 101 does not orthogonally intersect the screen S. In such a case, a picture is displayed on the screen S as shown in FIG. 2B. More specifically, if the picture light L is projected onto the screen S from a diagonally downward position, the picture that should be rectangular when displayed on the screen S would have a height Y (i.e., dimension of picture in the vertical direction) that is increased and a width (i.e., dimension of picture in the horizontal direction) that is varied. As a result, the displayed picture would be trapezoidal in which the upper part of the picture would have a width X1 and the lower part of the picture would have a width X2, which is smaller than the width X1.

To solve this problem, a projection-type picture display device known in the art performs trapezoidal distortion correction so that the picture that should be rectangular when displayed on a screen is not distorted into a trapezoidal shape regardless of how the display device is set up. A projection-type picture display device that performs trapezoidal distortion correction reduces the height of a picture by changing an aspect ratio of the picture so as not to display the picture of FIG. 2B. Furthermore, the projection-type picture display device performs trapezoidal distortion correction on a picture so that the displayed picture has a uniform width and becomes rectangular as shown in FIG. 1B. In this manner, in addition to performing trapezoidal distortion correction, the projection-type picture display device converts the aspect ratio of the picture.

In addition to displaying a picture based on a picture signal, a device for displaying a picture also implements a known on-screen display (OSD) function, which superimposes images such as characters and designs onto a displayed picture to present the user with information. In a projection-type picture display device implementing the OSD function, the OSD function may not be able to appropriately superimpose an image (hereinafter referred to as the “OSD image”) onto a picture. More specifically, in a projection-type picture display device that performs trapezoidal distortion correction, when the aspect ratio of the picture is changed, part of an OSD image may overhang from a picture when superimposed on the picture. In such a case, part of the OSD image would be missing when superimposed on the picture.

Accordingly, to prevent such partial overhanging of an OSD image from a picture onto which it is superimposed, Japanese Laid-Open Patent Publication No. 2007-193204 suggests changing the position at which the OSD image is superimposed on a picture. The publication also suggests deleting part of the OSD image (OSD menu item) in accordance with a predetermined display priority order.

However, in the above-described prior art, it is obvious that an OSD image cannot be entirely displayed when deleting part of the OSD image in accordance with the predetermined display priority order. Further, even if the position at which a OSD image is superimposed on a picture were to be changed, the OSD image may not be entirely superimposed on the picture. In other words, if an OSD image is large and the aspect ratio of a picture is changed, the OSD may not be entirely superimposed with the picture, and part of the OSD image may overhang from the picture. As a result, the entire OSD image cannot be displayed in a state superimposed on the picture. In particular, if the OSD image is a closed caption (i.e., subtitle or narration), it would be difficult to entirely superimpose a closed caption onto a picture when the aspect ratio is changed, and it would be inconvenient if the OSD image cannot be entirely displayed in a state superimposed on the picture.

### SUMMARY OF THE INVENTION

The present invention provides a projection-type picture display device capable of entirely displaying an OSD image superimposed on a picture so that part of the OSD image does not overhang from the picture.

One aspect of the present invention is a projection-type picture display device for projecting and displaying a picture. The projection-type picture display device includes an aspect ratio changing unit which changes an aspect ratio of the picture to adjust the size of the picture. An image generation unit generates an on-screen display image including characters superimposed on the picture. An image synthesizing unit synthesizes the on-screen display image with the picture of which the aspect ratio has been changed to superimpose the on-screen display image on the picture. A trapezoidal distortion correction unit performs trapezoidal distortion correction on the picture that has been synthesized with the on-screen display image in the image synthesizing unit. The image generation unit generates the on-screen display image by adjusting the size of the characters in the on-screen display image in accordance with the size of the picture of which the aspect ratio has been changed.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a diagram illustrating an example in which the optical axis of picture light projected from a projection lens of a projection-type picture display device orthogonally intersects a screen;

FIG. 1B is a diagram illustrating an example in which a rectangular picture is correctly displayed on the screen by the picture light of FIG. 1A;

FIG. 2A is a diagram illustrating an example in which the optical axis of the picture light projected from the projection lens of the projection-type picture display device does not orthogonally intersect the screen;

FIG. 2B is a diagram illustrating an example in which a trapezoidal picture is displayed on the screen by the picture light of FIG. 2A;

FIG. 3 is a block diagram illustrating a projection-type picture display device according to a preferred embodiment of the present invention;

FIG. 4 is a flowchart illustrating the operation of the projection-type picture display device of FIG. 3;

FIG. 5 is a diagram illustrating a picture;

FIG. 6 is a diagram illustrating a picture of which the aspect ratio is changed;

FIG. 7 is a diagram illustrating a closed caption, or an OSD image, displayed in a state superimposed on a picture;

FIG. 8 is a diagram illustrating a state in which part of a subtitle, or OSD image, overhangs from a picture of which the aspect ratio is changed;

FIG. 9 is a diagram illustrating a subtitle, or OSD image, in which the size of characters and the size of the spacing between character lines are adjusted;

FIG. 10 is a diagram illustrating a state in which a resized subtitle, or OSD image, is superimposed on a picture of which the aspect ratio is changed;

FIG. 11 is a diagram illustrating a synthesized picture that has undergone trapezoidal distortion correction;

FIG. 12 is a diagram illustrating a state in which the synthesized picture that has undergone the trapezoidal distortion correction is projected and displayed;

FIG. 13 is a block diagram illustrating a projection-type picture display device according to a modification of the preferred embodiment of the present invention;

FIG. 14 is a flowchart illustrating the operation of the projection-type picture display device of FIG. 13; and

FIG. 15 is a block diagram illustrating a projection-type picture display device according to a further modification of the preferred embodiment of the present invention.

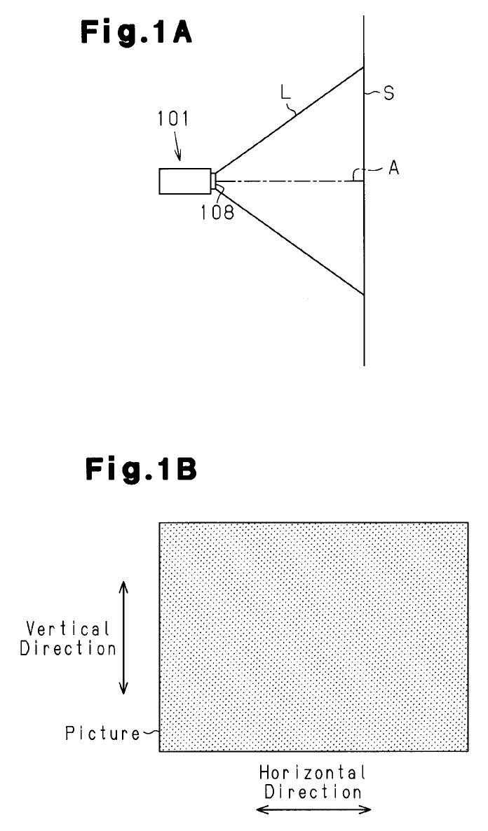

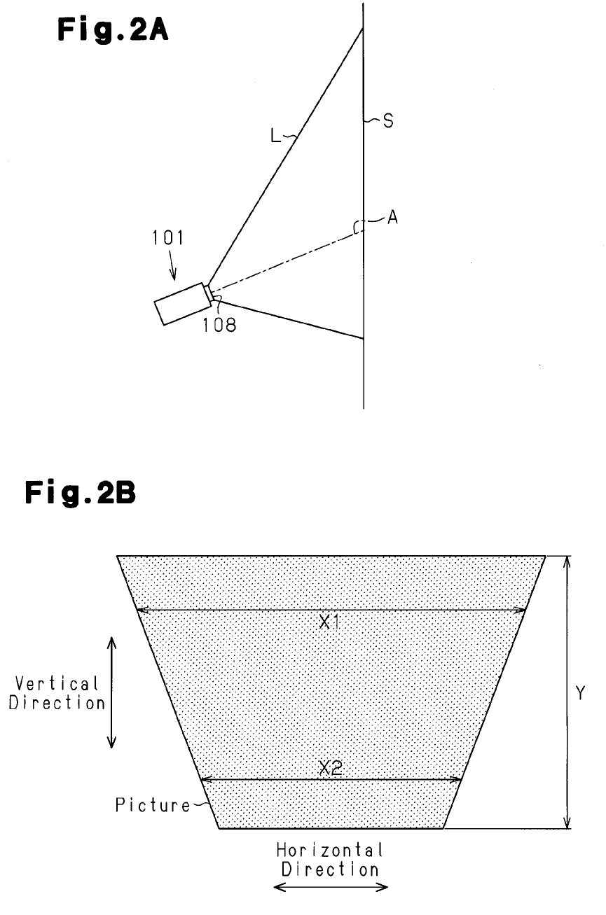

### DETAILED DESCRIPTION OF THE PREFERRED EMBODIMENTS

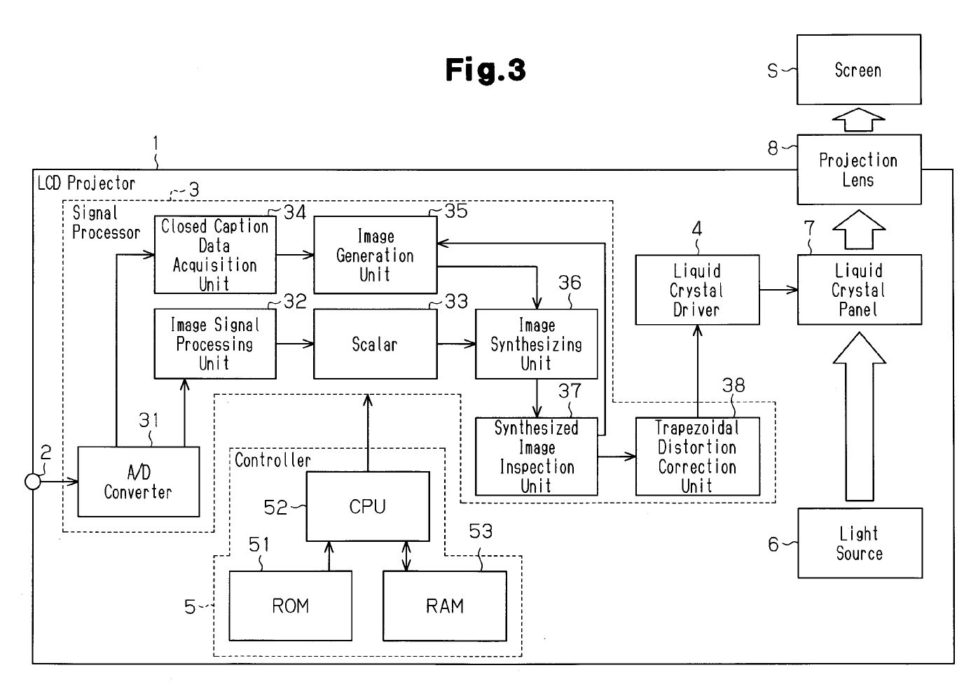

A projection-type picture display device according to a preferred embodiment of the present invention will now be discussed with reference to the drawings. Referring to FIG. 3, a liquid crystal display projector 1, which serves as a projection-type picture display device, generates picture light by transmitting light, which is emitted from a light source 6, through a liquid crystal panel 7, and projects the picture light onto a screen S. This displays a picture on the screen S. The liquid crystal display projector 1 implements an OSD function for displaying an image, such as characters and designs, in a state superimposed on a picture.

Referring to FIG. 3, the liquid crystal display projector 1 includes an input terminal 2, which is a signal input unit, for inputting a signal related to a projected and displayed picture, a signal processor 3 for performing predetermined signal processing on the input signal, a liquid crystal driver 4 for receiving the signal processed by the signal processor 3, and a controller 5 for controlling the signal processor 3 and the liquid crystal driver 4.

The signal processor 3, for example, includes an A/D converter 31, a picture signal processing unit 32, a scalar 33, a closed caption data acquisition unit 34, an image generation unit 35, an image synthesizing unit 36, a synthesized picture inspection unit 37, and a trapezoidal distortion correction unit 38. The units 31 to 38 of the signal processor 3 are each formed by a discrete integrated circuit (not shown).

The controller 5 includes a ROM 51 which is a storage for storing programs and the like, a CPU 52 for performing calculations based on the programs stored in the ROM 51, and a RAM 53 used by the CPU 52 when performing calculations. The controller 5 provides control signals for controlling the signal processor 3 and the liquid crystal driver 4 to each of the units 31 to 38 in the signal processor 3 and the liquid crystal driver 4. The controller 5 also provides as signals information and data necessary for the operation of each of the units 31 to 38 in the signal processor 3.

The liquid crystal display projector 1 also includes, as optical components, the light source 6, the liquid crystal panel 7 driven by the liquid crystal driver 4 and transmitting the light emitted from the light source 6, and the projection lens 8 for projecting the light transmitted through the liquid crystal panel 7 onto the screen S.

The operation of the liquid crystal display projector 1 from when a signal related to a picture is input to the liquid crystal display projector 1 until when the picture of the signal is displayed on the screen S will now be described.

The input terminal 2 is a composite terminal input, which receives a composite picture signal (hereinafter simply referred to as “picture signal”) generated by a composite of picture signals such as a color signal and a luminance signal. Further, the input terminal 2 is connected to an external device (not shown) by a cable (not shown). The external device sends an NTSC picture signal, which is used for analog broadcasts, to the input terminal 2. The input terminal 2 provides the input picture signal to the signal processor 3.

The signal processor 3 performs various types of signal processing on the picture signal input to the input terminal 2. Then, the signal processor 3 provides the picture signal that has undergone signal processing on the liquid crystal driver 4. The signal processor 3 performs, for example, a process for changing the format of a picture signal, a process for changing the size of a picture (i.e., height of picture, width of picture) corresponding to the picture signal, and a process for correcting trapezoidal distortion so that a picture displayed on the screen S is rectangular.

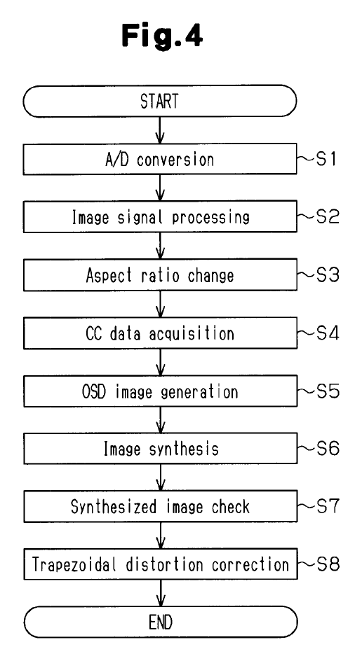

The operation performed by each of the units 31 to 38 in the signal processor 3 shown in FIG. 3 will now be discussed in more detail with reference to FIGS. 4 to 11.

As shown in FIG. 4, the A/D converter 31 first performs a process for converting an NTSC picture signal, which is input to the signal processor 3, from an analog signal to a digital signal (step S1). The A/D converter 31 provides the picture signal, which has been converted to a digital signal, to both the picture signal processing unit 32 and the closed caption data acquisition unit 34.

The picture signal processing unit 32 then performs various types of picture signal processing on the picture signal of the digital signal (step S2). For instance, the picture signal processing unit 32 performs a process for converting a picture signal, which contains a color signal and a luminance signal, to an RCB picture signal, which is related with the three primary colors (red, green, and blue) of light, based on the hue and luminance corresponding to the color signal and the luminance signal, and performs a process for converting a picture signal, which is an interlace scan signal, to a picture signal, which is a progressive scan signal. The picture signal processing unit 32 may also perform a gamma correction process on a picture signal, which is a digital signal. The picture signal processing unit 32 provides the scalar 33 with picture signals that have undergone various types of picture signal processing.

The scalar 33, which is an aspect ratio changing unit, processes signals that have undergone various types of picture signal processing in the picture signal processing unit 32 to change the aspect ratio of a picture (step S3). When the optical axis of the picture light projected from the projection lens 8 of the liquid crystal display projector 1 does not orthogonally intersect the screen S, the height and width of a picture displayed on the screen S must be prevented from increasing. The scalar 33 changes the aspect ratio (horizontal to vertical ratio, ratio expressed by “width of picture: height of picture”) of a projected picture generated by picture signals prior to the trapezoidal distortion correction when the optical axis of the picture light projected by the projection lens 8 of the liquid crystal display projector 1 does not orthogonally intersect the screen S.

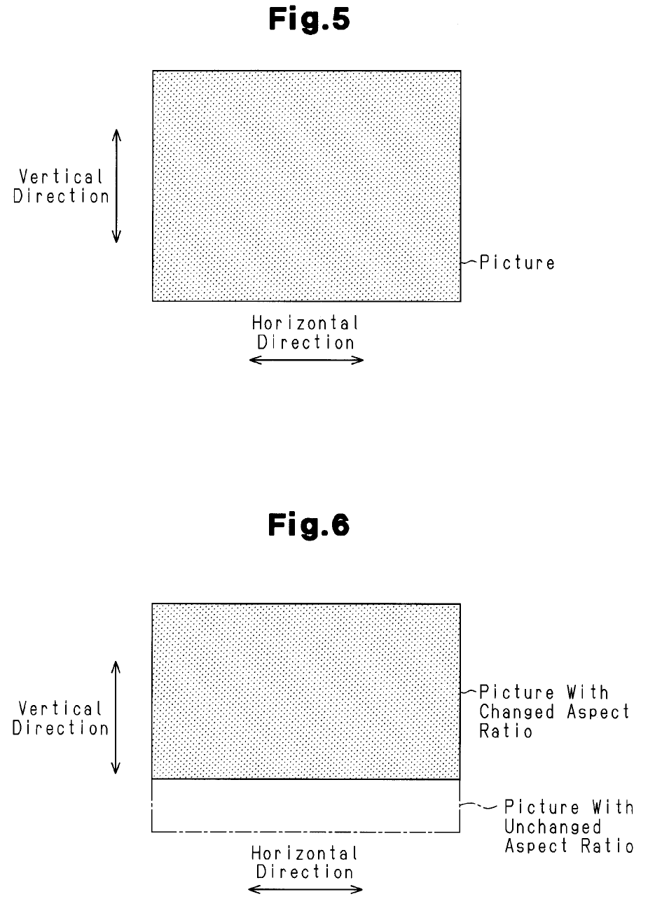

For instance, the scalar 33 is provided with a picture signal for a picture having an aspect ratio of 4:3, as shown in FIG. 5. When the picture light is projected from a position located diagonally downward from the screen S, the height of the picture (e.g., dimension of picture in the vertical direction) displayed on the screen S must be prevented from increasing. The scalar 33 thus performs a process for changing the aspect ratio of the picture so that the picture is reduced in size in the vertical direction, as shown in FIG. 6. The scalar 33 then provides the image synthesizing unit 36 with a picture signal that has undergone the process for changing the aspect ratio (i.e., picture signal for a picture of which the aspect ratio is changed).

When the picture light is projected from a position located diagonally sideward from the screen S, the width of the picture (i.e., dimension of picture in the horizontal direction) displayed on the screen S must be prevented from increasing. In such a case, the scalar 33 may perform a process for changing the aspect ratio of the picture so that the picture is reduced in size in the horizontal direction. In other words, the scalar 33 is not limited to reducing the size of the picture in the vertical direction and may also perform a process for adjusting the aspect ratio (i.e., changing the aspect ratio) on a picture signal so that the projected and displayed picture has a predetermined size (i.e., height and width).

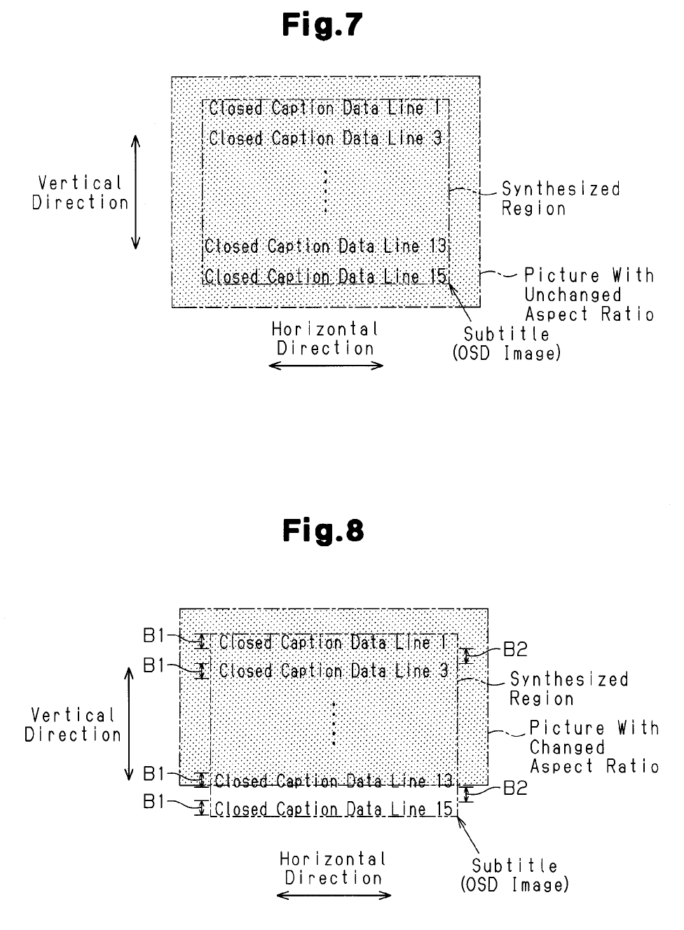

The closed caption data acquisition unit 34 acquires data related to a closed caption from the NTSC picture signal (step S4). More specifically, a vertical blanking interval (VBI) of picture signals carries data related to a closed caption (also referred to as “CC data”), and the closed caption data acquisition unit 34 acquires the CC data from the vertical blanking interval. The closed caption is content that allows the user to decide whether or not to superimpose an image on a displayed picture, in which the closed caption refers to subtitles in the preferred embodiment. Referring to FIG. 7, a picture in which the aspect ratio is unchanged includes a region used to superimpose an entire subtitle (hereinafter referred to as “synthesizing region”). The closed caption data acquisition unit 34 provides the acquired CC data (i.e., data related to subtitle) to the image generation unit 35.

Based on the CC data acquired by the closed caption data acquisition unit 34, the image generation unit 35 generates an OSD image, which contains characters such as a subtitle (step S5). The OSD is superimposed on a projected and displayed picture. The image generation unit 35 provides the image synthesizing unit 36 with the OSD image signal of the generated subtitle.

The image generation unit 35, for example, generates a subtitle using character data related to a predetermined character size, which is stored in the ROM 51, based on the CC data and input signal. The ROM stores segments of character data, each related to a different character size. More specifically, when superimposing subtitles on a picture of which the aspect ratio has been changed, the image generation unit 35 selects from the segments of character data stored in the ROM 51 the character data related to a character size allowing a subtitle to be entirely superimposed on a picture. Thus, the image generation unit 35 can adjust the font size (i.e., character size) by changing the character data used to generate a subtitle so that the entire subtitle is superimposed on a picture.

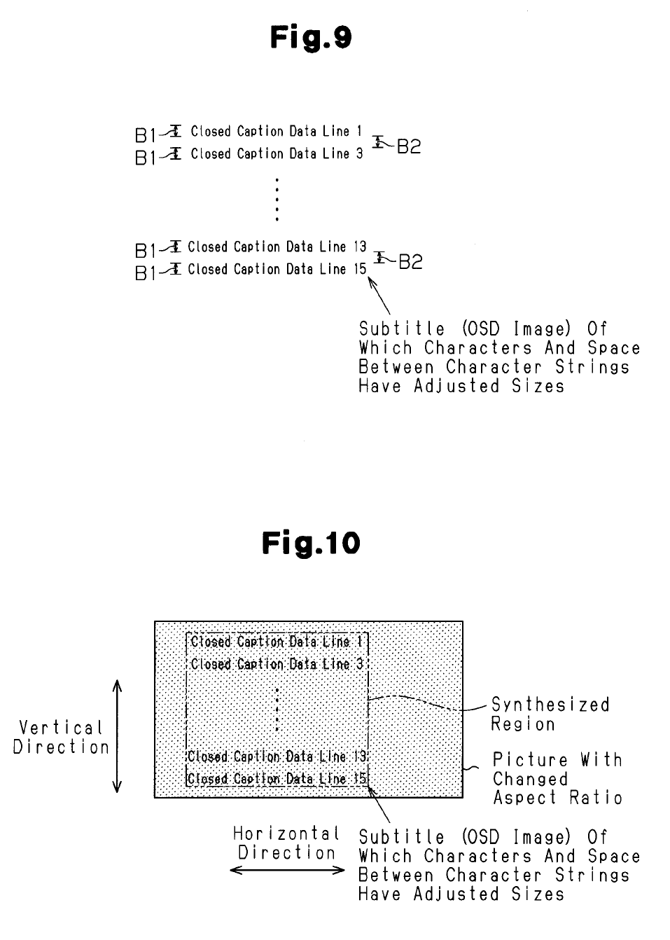

As shown in FIG. 8, when the size of the synthesizing region is large compared to the size of a picture of which the aspect ratio is changed, the entire OSD image cannot be synthesized with the picture. Thus, part of the subtitle overhangs from the picture of which the aspect ratio is changed. Therefore, referring to FIG. 9, the image generation unit 35 generates a subtitle so that the size B1 of characters and the size B2 of the spacing between character lines in the subtitle is decreased compared to when part of the subtitle overhangs from the picture of which the aspect ratio is changed. In this manner, the image generation unit 35 adjusts the size B1 of characters and the size B2 of the spacing between character lines to generates a subtitle so that the entire subtitle is superimposed on a picture of which the aspect ratio is changed to thereby reduce the synthesizing region in the picture of which the aspect ratio is changed. The image generation unit 35 then provides the image synthesizing unit 36 with a signal related the generated subtitle. The operations in step S2 and step S3 are performed in parallel with the operations in step S4 and step S5.

Referring to FIG. 10, the image synthesizing unit 36 synthesizes the subtitle generated in step S5 with the picture of which the aspect ratio has been changed in step S3 to superimpose the subtitle on the picture (step S6). In other words, the image synthesizing unit 36 synthesizes the OSD image signal with the picture signal for the picture of which the aspect ratio is changed so that the subtitle is superimposed on the picture of which the aspect ratio is changed. The image synthesizing unit 36 provides the synthesized picture inspection unit 37 with the picture signal that has been synthesized with the OSD image signal.

The synthesized picture inspection unit 37 determines whether or not the entire subtitle is superimposed on the picture of which the aspect ratio has been changed in step S3 (step S7). For example, the synthesized picture inspection unit 37 compares the size of the picture of the provided picture signal and the size of the picture of which the aspect ratio has been changed by the scalar 33. The synthesized picture inspection unit 37 determines that the entire subtitle is not superimposed on the picture if the size of the picture of the picture signal provided to the synthesized picture inspection unit 37 is larger than the size of the picture of which the aspect ratio has been changed by the scalar 33. In this case, the synthesized picture inspection unit 37 provides the image generation unit 35 with a signal requesting readjustment of the synthesizing region (size B1 of characters and/or size B2 of spacing between character lines) for the subtitle in the picture and generation of the subtitle in the readjusted state.

When the optical axis of the picture light projected by the projection lens 8 of the liquid crystal display projector 1 does not orthogonally intersect the screen S, the trapezoidal distortion correction unit 38 performs trapezoidal distortion correction on the picture that has been synthesized with the subtitle in step S6 (step S8). That is, the trapezoidal distortion correction unit 38 performs a process for correcting trapezoidal distortion on the picture signal of the picture synthesized with the subtitle so that the picture displayed on the screen S has a uniform height and uniform width.

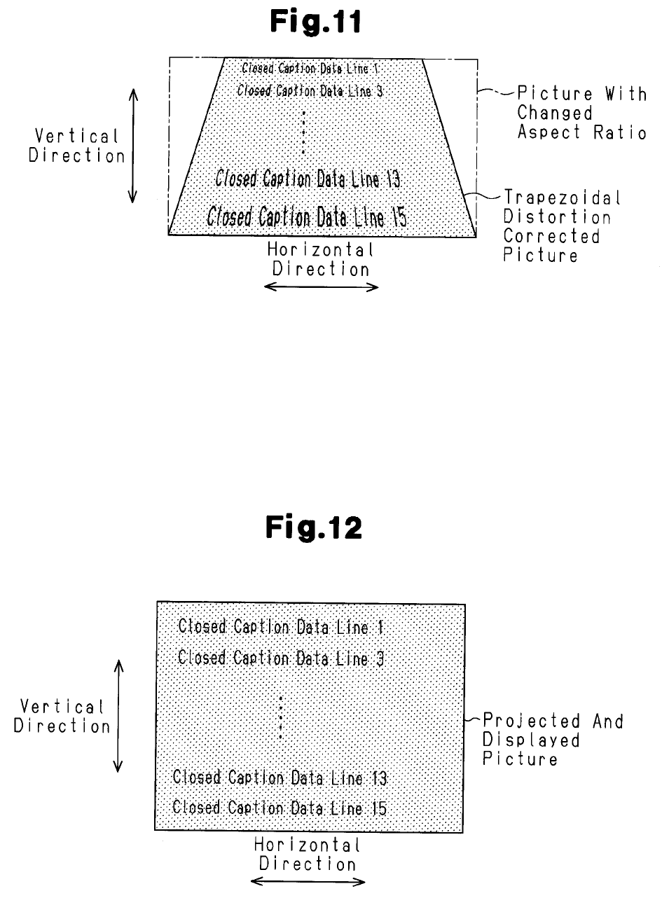

For example, when the picture light is projected from a position located diagonally downward from the screen S, the width of the upper part of a picture displayed on the screen S must be prevented from becoming larger than the width of the lower part of the picture. The trapezoidal distortion correction unit 38 thus performs a process for correcting the trapezoidal distortion of the picture displayed on the screen S so that the width at the upper part of the picture becomes smaller than the width at the lower part of the picture, as shown in FIG. 11. The signal processor 3 then provides the liquid crystal driver 4 with a picture signal that has undergone the process for correcting the trapezoidal distortion.

When the picture light is projected from a position located diagonally sideward from the screen S, the height of the picture (i.e., dimension of picture in the vertical direction) displayed on the screen S must be uniform. In such a case, the trapezoidal distortion correction unit 38 performs a process for correcting the trapezoidal distortion of the picture so that the height of one horizontal end of the picture is smaller than the height of the other horizontal end of the picture. In other words, the trapezoidal distortion correction unit 38 is not limited to just adjusting the width of the picture and may perform a process on a picture signal to correct trapezoidal distortion of a projected and displayed picture so that the picture has uniform height and width (i.e., trapezoidal distortion correcting process).

The picture signal that has undergone the process for changing the aspect ratio and the process for correcting trapezoidal distortion in the signal processor 3 as described above is provided to the liquid crystal driver 4. The liquid crystal driver 4 drives the liquid crystal panel 7 by applying voltage to the liquid crystal panel 7 in accordance with the picture signal to form a picture on the liquid crystal panel 7. The liquid crystal panel 7 is a light valve using an active matrix drive type thin film transistor (TFT), and the liquid crystal driver 4 includes a source driver and gate driver or integrated circuits for driving the source and gate of the thin film transistor.

The light emitted from the light source 6 is transmitted through the liquid crystal panel 7 on which a picture is formed to generate picture light. The projection lens 8 projects the picture light onto the screen S. In this manner, the liquid crystal display projector 1 projects and displays a picture. The signal processor 3 performs processes on a picture signal to change the aspect ratio and correct the trapezoidal distortion. Thus, as shown in FIG. 12, a rectangular picture is displayed on the screen S even if the picture light is projected from a diagonally downward position. Furthermore, the signal processor 3 adjusts the synthesizing region (the size B1 of characters and/or the size B2 of spacing between character lines) of a subtitle in a picture in accordance with the size of the picture of which the aspect ratio is changed based on a signal from the synthesized picture inspection unit 37. Thus, the entire subtitle is properly synthesized with the picture, as shown in the state of FIG. 12.

The liquid crystal display projector 1 implementing the OSD function in the preferred embodiment has the advantages described below.

(1) The liquid crystal display projector 1 includes the scalar 33 for adjusting the size of a projected picture by changing the aspect ratio of the picture, the image generation unit 35 for generating a subtitle superimposed on the picture, and the image synthesizing unit 36 for synthesizing the subtitle with the picture of which the aspect ratio has been changed to superimposing the subtitle on the picture. The liquid crystal display projector 1 also includes the trapezoidal distortion correction unit 38 for performing trapezoidal distortion correction on the picture synthesized with the subtitle. The image generation unit 35 generates the subtitle by adjusting the size of the characters in the subtitle in accordance with the size of the picture of which the aspect ratio has been changed. Thus, the image generation unit 35 adjusts the size of the characters in the subtitle and generates a subtitle that is superimposed on the picture in accordance with the size (i.e., dimensions of picture in vertical and horizontal directions) of the picture of which the aspect ratio is changed. Therefore, the region used to superimpose the entire subtitle on the picture of which the aspect ratio is changed is decreased by adjusting the size of the characters in the subtitle. In other words, the subtitle is generated so that the entire subtitle is superimposed on the picture. Since the image synthesizing unit 36 properly synthesizes the entire subtitle with the picture of which the aspect ratio has been changed, the entire subtitle is displayed in a state superimposed on the picture without the subtitle partially overhanging from the picture. Furthermore, the trapezoidal distortion correction unit 38 performs trapezoidal distortion correction on the picture that has been synthesized with the subtitle. Thus, trapezoidal distortion correction is performed on the picture and also the subtitle, which is superimposed on the picture. Accordingly, in addition to performing trapezoidal distortion correction on a picture, the trapezoidal distortion correction unit 38 performs trapezoidal distortion correction on a subtitle that is superimposed on the picture.

(2) A subtitle includes characters and a plurality of character lines. The image generation unit 35 adjusts the spacing of the characters (i.e., size B2 between character lines) to generate a subtitle. Thus, the subtitle is entirely superimposed on a picture without lowering the visualness of the characters when the characters in the subtitle are reduced in size.

(3) The liquid crystal display projector 1 further includes the input terminal 2, which receives picture-related signals, and the closed caption data acquisition unit 34, which acquires data related to a closed caption from the signals. The image generation unit 35 generates a subtitle based on the CC data acquired by the closed caption data acquisition unit 34. Thus, data related to the closed caption (i.e., subtitle) is used to generate a closed caption. This enables prevention of partial overhanging of a closed caption from a picture.

(4) The liquid crystal display projector 1 further includes the synthesized picture inspection unit 37 for determining whether or not a subtitle is entirely superimposed on a picture with which the subtitle is synthesized. The image generation unit 35 generates a subtitle based on the determination result of the synthesized picture inspection unit 37. Thus the synthesized picture inspection unit 37 checks whether or not part of a subtitle overhangs from a picture. If the entire subtitle is not superimposed on the picture, the image generation unit 35 automatically adjusts the size of the characters in the subtitle so as to superimpose the entire subtitle on the picture.

(5) The liquid crystal display projector 1 further includes the ROM 51 for storing segments of character data for different character sizes. The image generation unit 35 selects character data for characters having a predetermined size from the segments of character data stored in the ROM to adjust the size B1 of characters and the size B2 of the spacing between character lines in a subtitle. Thus, to adjust the character size B1 of a subtitle, there is no need for performing calculations, such as a calculation for changing dimensions in the vertical and horizontal directions of the characters. The liquid crystal display projector 1 thus easily generates a subtitle including characters that can be entirely superimposed on a picture.

It should be apparent to those skilled in the art that the present invention may be embodied in many other specific forms without departing from the spirit or scope of the invention. Particularly, it should be understood that the preferred embodiment may be modified as described below. These modifications have at least the above-described advantage (1).

In the preferred embodiment, the image generation unit 35 may adjust the character size B1 by performing, on the character data, a calculation process for changing the dimensions in the vertical and horizontal directions of the character instead of storing segments of character data in the ROM 51. The image generation unit 35 may also perform, on the character data, a calculation for changing the size B2 of the spacing between character lines.

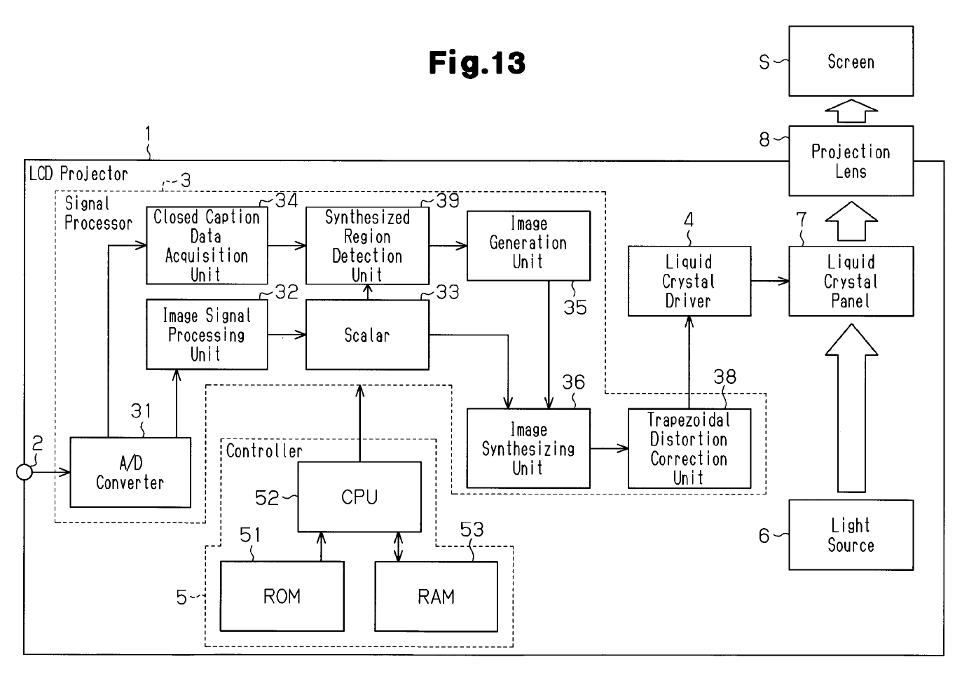

In the preferred embodiment, determination of whether or not a subtitle overhangs from a picture (i.e., whether or not an entire subtitle is superimposed) may be performed before the subtitle is synthesized with the picture. In this case, the liquid crystal display projector 1 may include a synthesizing region detection unit 39 in lieu of the synthesized picture inspection unit 37 (FIG. 3), as shown in FIG. 13.

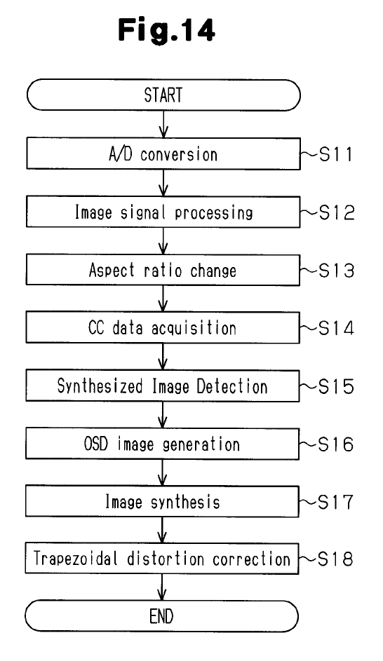

The synthesizing region detection unit 39 is an integrated circuit for detecting the region used to superimpose an entire subtitle in a picture of which the aspect ratio is changed. The operation of each of the units 31 to 38 in the signal processor 3 of the liquid crystal display projector 1 including the synthesizing region detection unit 39 will now be discussed with reference to FIG. 14.

A picture signal input to the signal processor 3 is provided to the A/D converter 31. The A/D converter 31 performs a process for converting the picture signal to a digital signal (step S11) in the same manner as in step S1. The A/D converter 31 provides the picture signal, which has been converted to a digital signal, to both the picture signal processing unit 32 and the closed caption data acquisition unit 34.

The picture signal processing unit 32 then performs various types of picture signal processing on the digital picture signal (step S12) in the same manner as in step S2. The picture signal processing unit 32 provides the scalar 33 with the picture signal that has undergone various types of picture signal processing.

Then, in the same manner as in step S3, the scalar 33 performs a scaling process on the picture signal, which has undergone various types of picture signal processing in the picture signal processing unit 32, to change the size of the picture of the picture signal (step S13). In step S13, the scalar 33, which serves as an aspect ratio changing unit, changes the aspect ratio of the displayed picture of the picture signal in the same manner as in the preferred embodiment. The scalar 33 provides the image synthesizing unit 36 and the synthesizing region detection unit 39 with the picture signal that has undergone the process of changing the aspect ratio (i.e., picture signal indicating the picture of which the aspect ratio is changed).

In the same manner as in step S4, the closed caption data acquisition unit 34 acquires the CC data from the NTSC picture signal (step S14). The closed caption data acquisition unit 34 provides the synthesizing region detection unit 39 with the acquired CC data (i.e., data related to a subtitle). The operations in step S12 and step S13 are performed in parallel with the operation in step S14.

Then, the synthesizing region detection unit 39 detects the size of the synthesizing region by detecting the dimensions of the subtitle in the vertical and horizontal directions from the input CC data (step S15). The synthesizing region detection unit 39 then detects the size of the picture from the picture signal, compares the size of the synthesizing region and the size of the picture, and determines whether or not the size B1 of characters and the size B2 of the spacing between character lines need to be adjusted when superimposing the subtitle on the picture. The image generation unit 35 must adjust the size B1 of characters and the size B2 of the spacing between character lines if the size of the picture is smaller than the size of the synthesizing region. If determined that the image generation unit 35 must adjust the size B1 of characters and the size B2 of the spacing between character lines, the synthesizing region detection unit 39 provides the image generation unit 35 with the CC data and a signal requesting for readjustment of the font size, that is, the size of the subtitle (OSD image) and generation of the subtitle in the readjusted state. If determined that the image generation unit 35 does not have to adjust the size B1 of characters and the size B2 of the spacing between character lines, the synthesizing region detection unit 39 provides the image generation unit 35 with only CCD data.

The image generation unit 35 then generates the OSD image (i.e., subtitle) including characters that is superimposed on the projected and displayed picture based on the CC data acquired by the closed caption data acquisition unit 34 and the input signal (step S16). The image generation unit 35 provides the image synthesizing unit 36 with a signal related to the generated subtitle.

The image synthesizing unit 36 then synthesizes the subtitle generated in step S16 with the picture of which the aspect ratio has been changed in step S13 to superimpose the subtitle on the picture (step S17). The image synthesizing unit 36 provides the trapezoidal distortion correction unit 38 with a picture signal related to the picture synthesized with the subtitle.

In the same manner as in step S8, the trapezoidal distortion correction unit 38 performs trapezoidal correction on the picture that has been synthesized with the subtitle in step S17 (step S18). The signal processor 3 provides the liquid crystal driver 4 with the picture signal that has undergone the process for correcting the trapezoidal distortion.

As described above, the image generation unit 35 generates a subtitle based on the detection result of the synthesizing region detection unit 39. Therefore, the synthesizing region detection unit 39 checks whether part of the subtitle overhangs from a picture before the subtitle is synthesized with the picture. The image generation unit 35 automatically adjusts the size of the characters in the subtitle so that the entire subtitle is superimposed on the picture. The liquid crystal display projector 1 may include both the synthesized picture inspection unit 37 and the synthesizing region detection unit 39.

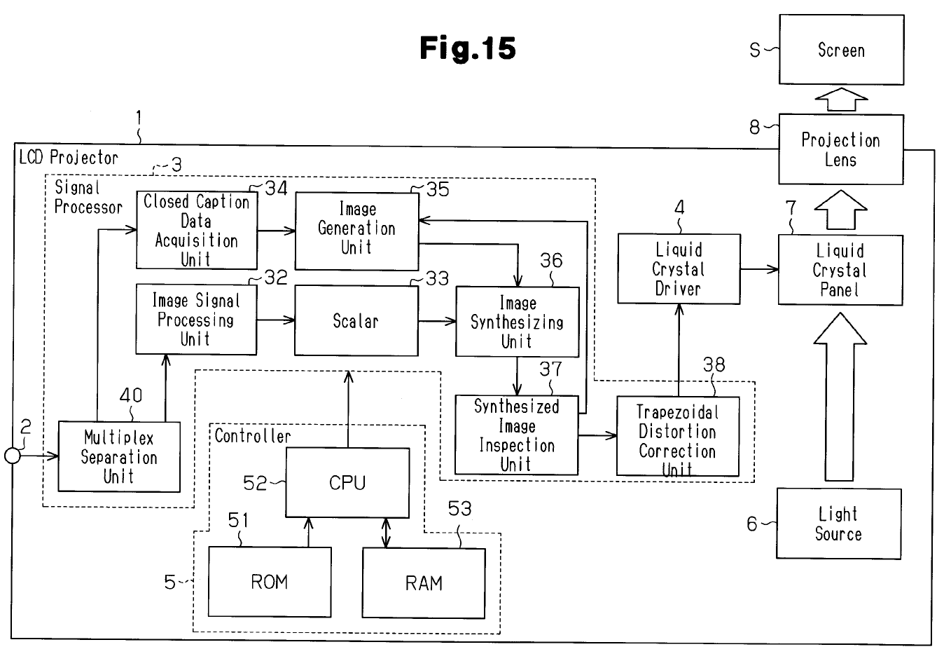

In the preferred embodiment, the NTSC picture signal, which is used for analog broadcasts, is input to the input terminal 2. However, other signals may be input. Further, a picture signal may be a signal multiplexed with picture data or subtitle data based on the MPEG-2 Systems standard used in digital broadcasts or the like. In such a case, the liquid crystal display projector 1 is formed as shown in FIG. 15. In FIG. 15, like or same reference numerals are given to those components that are the same as the corresponding components of the preferred embodiment, and such components will not be described.

The input terminal 2 may be an HDMI terminal, which receives a signal multiplexed with picture data and subtitle data (hereinafter referred to as the “multiplexed signal”). Further, the input terminal 2 is connected to an external device (not shown) by a cable (not shown). The multiplexed signal input to the input terminal 2 from the external device is provided to the signal processor 3.

The signal processor 3 includes a multiplex separation unit 40 (so-called demultiplexer), which separates the picture data and subtitle data from the multiplexed signal, in lieu of the A/D converter 31 used in the preferred embodiment. The multiplex separation unit 40 provides the separated picture data to the picture signal processing unit 32 as a picture signal, which is a digital signal, and the separated subtitle data to the closed caption data acquisition unit 34.

Therefore, the closed caption data acquisition unit 34 does not acquire subtitle data from a vertical blanking interval of picture signals. The closed caption data acquisition unit 34 acquires subtitle data from the multiplex separation unit 40. The closed caption data acquisition unit 34 provides the image generation unit 35 with CC data.

In the preferred embodiment, an OSD image displayed in a state superimposed on a picture by the OSD function is a subtitle indicating the content of the picture. However, the OSD image may be a narration that is not relevant to the content of the picture. In this manner, the OSD image may be any kind of a closed caption such as subtitle or a narration.

In the preferred embodiment, the OSD image is a subtitle, which is a closed caption. However, the OSD image is not limited to a closed caption. In other words, the OSD image may be any image displayed in a state superimposed on the picture by the OSD function. For example, the OSD image may be an image that presents the user with information for setting the liquid crystal display projector 1. Therefore, if an OSD image superimposed on a picture is not a closed caption, the closed caption data acquisition unit 34 may be eliminated.

In the preferred embodiment, a subtitle, which is the OSD image, is generated by adjusting the size B1 of characters and the size B2 of the spacing between character lines. However, the size of the OSD image may be changed by adjusting only the size B1 of the characters.

In the preferred embodiment, each of the units 31 to 38 in the signal processor 3 is formed and operated by a discrete integrated circuit and operated. However, the operation of each of the units 31 to 38 in the signal processor 3 may be executed in accordance with a program. That is, the CPU 52 may entirely or partially function as each of the units 31 to 38 in the signal processor 3. This would simplify the hardware structure of the liquid crystal display projector 1. The CPU 52 may functions as the synthesizing region detection unit 39 and the multiplex separation unit 40.

In the preferred embodiment, the projection-type picture display device is the liquid crystal display projector 1. However, the projection-type picture display device may be any device as long as it implements an OSD function (i.e., superimpose an OSD image on a picture) and projects and displays pictures.

The present examples and embodiments are to be considered as illustrative and not restrictive, and the invention is not to be limited to the details given herein, but may be modified within the scope and equivalence of the appended claims.

What is claimed is:

1. A projection-type picture display device for projecting and displaying a picture, the projection-type picture display device comprising:
an aspect ratio changing unit which changes an aspect ratio of the picture to adjust the size of the picture;
an image generation unit which generates an on-screen display image including characters superimposed on the picture;
an image synthesizing unit which synthesizes the on-screen display image with the picture of which the aspect ratio has been changed to superimpose the on-screen display image on the picture; and
a trapezoidal distortion correction unit which performs trapezoidal distortion correction on the picture that has been synthesized with the on-screen display image in the image synthesizing unit;
wherein the image generation unit generates the on-screen display image by adjusting the size of the characters in the on-screen display image in accordance with the size of the picture of which the aspect ratio has been changed.

2. The projection-type picture display device according to claim 1, wherein the image generation unit generates the on-screen display image by adjusting the spacing of the characters in the on-screen display image.

3. The projection-type picture display device according to claim 1, wherein:
the on-screen display image includes a plurality of character lines; and
the image generation unit generates the on-screen display image by adjusting the spacing of the character lines.

4. The projection-type picture display device according to claim 1, wherein the image generation unit adjusts at least one of the size and spacing of the characters in the on-screen display image to change a synthesizing region of the on-screen display image on the picture of which the aspect ratio has been changed.

5. The projection-type picture display device according to claim 1, further comprising:
a signal input unit which receives a signal related to the picture, in which the signal includes data related to a closed caption; and
a closed caption data acquisition unit which acquires the data related to the closed caption from the signal;
wherein the image generation unit generates the on-screen display image based on the data related to the closed caption acquired by the closed caption data acquisition unit.

6. The projection-type picture display device according to claim 1, further comprising:
a synthesized picture inspection unit which determines whether or not the entire on-screen display image is superimposed on the picture of which the aspect ratio has been changed;
wherein the image generation unit generates the on-screen display image based on the determination of the synthesized picture inspection unit.

7. The projection-type picture display device according to claim 6, wherein the trapezoidal distortion correction unit is connected to the synthesized picture inspection unit.

8. The projection-type picture display device according to claim 1, further comprising:
a synthesizing region detection unit for detecting the size of a region used to superimpose the entire on-screen display image on the picture of which the aspect ratio has been changed;
wherein the image generation unit generates the on-screen display image based on the detection of the synthesizing region detection unit.

9. The projection-type picture display device according to claim 8, wherein the synthesizing region detection unit is connected to the aspect ratio changing unit.

10. The projection-type picture display device according to claim 1, further comprising:
a storage for storing segments of character data, each related to a different character size;
wherein the image generation unit selects character data related to a predetermined character size from the segments of character data and uses the selected character data to adjust the size of the characters in the on-screen display image.
